(19) United States
(12) Patent Application Publication
(10) Pub. No.: US 2011/0253661 A1
(43) Pub. Date: Oct. 20, 2011

(54) OFFSHORE LIFTING OPERATIONS

(76) Inventors: Stuart Neil Smith, Aberdeenshire (GB); David Alexander James Sinclair, Aberdeenshire (GB)

(21) Appl. No.: 12/998,445

(22) PCT Filed: Oct. 22, 2009
(86) PCT No.: PCT/GB2009/002519

§ 371 Date: Jun. 30, 2011

(30) Foreign Application Priority Data
Oct. 22, 2008 (GB) 0819400.3

(51) Int. Cl. B66C 23/62

(52) U.S. Cl. 212/255; 212/270

(57) ABSTRACT

An offshore, deep-water crane including a support structure, a lifting arm secured to the support structure and extending therefrom, and at least one lifting rope extending from the support structure towards an end of the lifting arm remote from the support structure is disclosed. The lifting rope has a specific gravity less than 3 and a traction winch for moving the at least one lifting rope from the support structure along the arm and vice versa.

The Applicant claims priority to International Number PCT/GB2009/002519 filed on Oct. 22, 2009, which claims priority to Great Britain Application Number 0819400.3, filed on Oct. 22, 2008.

The present invention relates to a method and apparatus for lifting loads on offshore vessels in deep water.

Hoists lift loads by running wire over pulleys to a winch. Generally, hoists are fixed structures; the pulleys are also generally fixed to the structure. The winch may also be fixed on or near the structure. Consequently a load can only be lifted or lowered where the hoist is fixed. Some hoist designs, however, allow for some movement, for instance, by changing the pulley positions on the fixed structure, or changing the lifting pulley angle relative to the structure.

Cranes are devices which comprise a winch and a lifting arm, such as a boom, with pulleys mounted at both the winch-end and at a point along, towards or at the end of the boom. Wires run from the winch via the pulleys to the point along, towards or at the end of the boom. The boom and winch are both mounted on a common chassis or support structure that may be fixed, or can rotate. The boom may be fixed horizontally with a travelling lift pulley (a configuration seen on tower cranes), or may be capable of changing its angle relative to the horizontal. By combining rotational and translational movements afforded by the mobility of the boom and support structure, the lift hook position of the crane relative to the ground can be adjusted, so that a load can be lifted/lowered anywhere within a crane's footprint.

There are a wide variety of well-known arrangements of cranes. The support structure may be fixed; such fixed support structures include pedestals and lattice structures. Alternatively the support structure may be rotatable. Typical lifting arms of the crane include stiff booms, telescopic booms, and articulated (knuckle) booms. The crane is typically controlled from a control cab, and powered by power packs (electric and/or hydraulic) contained in a machinery module. The machinery module may also be mounted on the support structure. A number of winches and/or hydraulic cylinders are appropriately placed throughout the crane, thereby allowing for hook movement, and boom movements (if the boom is moveable).

A crane allows for maneuvering of a load around the crane, as well as for lifting/lowering of the load, by a combination of rotating the crane (if the support structure is rotatable), and/or changing the angle and/or configuration of the crane boom (for instance, knuckle booms may be bent or straightened, and telescopic booms may be extended or contracted). Rotation of the crane is typically powered by electric or hydraulic drives. Typically, changes in the lifting arm angle, shape or configuration, for instance, with knuckle or telescopic booms, are achieved by winch/wire systems and/or hydraulic cylinders appropriately placed on the crane to enable movement. The typical configuration of a crane will vary, and may incorporate the above-described features in any combination as known by the person skilled in the art.

Thus, in essence cranes can be used to lift, lower and move loads around the crane, whereas hoists lift and lower in substantially one location. Cranes may be particularly desirable in certain applications where the ability to move loads around is required.

Modern oil exploration and recovery operations are conducted in ever-increasing depths of water. These operations are often conducted using offshore support vessels. Offshore support vessels may be fitted with heavy lift cranes, and generally can lift and lower loads of hundreds of tonnes to depths of several thousands of metres. Typical cranes can lift 250 tonnes, 400 tonnes, or even 800 tonnes at the surface. The length of lift wire used can be as great as 3000 metres long. For instance, when using 3000 metres of lift wire, having a weight of 300 tonnes, on a crane having a lifting capacity of 400 tonnes, the resulting useable capacity of the crane is 100 tonnes.

Cranes of offshore support vessels generally use steel wire as the lifting medium. The allowable safe working load (SWL), in other words, the useful capacity, of the crane wire is dependent on a number of factors including diameter and grade of the wire, as well as the dynamic lifting factors of the operation itself. Statutory factors of safety may also apply. These will generally define the SWL as a proportion of the wire breaking load, and may vary according to the conditions of use.

However, in very deep water, the weight of the steel wire itself (i.e. the “self-weight”) may make up a significant proportion of the overall weight to be lifted. Consequently, in very deep water, where long lengths of wires are required, the self-weight of the cable is large, and thus the useful capacity for a given wire can approach zero. Thus, in very deep water, the utility of a crane may be greatly reduced, or it may even be unusable.

Cranes suitable for shallow water (i.e. for depths of water less than 1000 meters from the surface) generally use a storage drum that also provides the lifting force via suitable drive motors attached to the storage drum. This configuration is problematic for deep or very deep-water operations, in that the storage drum needs to be very large to accommodate large amounts of large diameter wire. This heavy drum may have to be mounted up on the crane pedestal leading to reduced stability of the vessel on which it is carried. The reel drive torque also varies widely with the amount of wire stored on the drum, and at high tensions this can lead to top layers being driven into lower layers with the potential for damaging the lift wire. Other cranes capable of operating in deep or very deep water may use a traction winch and separate storage reel to overcome these problems, but are still subject to the problem of reduced load because of the self-weight of the steel wire.

Thus there is a need for improved lifting mediums that alleviate the problems of lifting and lowering loads in very deeps water. The present invention solves the problems of the prior art.

In broad terms the present invention provides a method and apparatus for lifting loads on offshore vessels in very deep water, by replacing the steel wire with a rope made of fibre. Typically any fibre rope may be characterised by not consisting of steel, and/or having a low specific gravity, typically in the range of 1.6 to 0.9. Suitable fibres for use with the present invention include synthetic fibres such as polyamide fibres and para-aramide fibres. Suitable polyamide fibres include nylon. Suitable para-aramids, which belong to a class of compounds known as aromatic polyamides, include poly-para-phenylene terephthalamide (commercially known as Twaron® or Kevlar®). It will be appreciated by the person skilled in the art that other materials may be suitable, including polyester, polypropylene, Polyethylene, High Modulus Polyethylene and Liquid Crystal Aromatic Polyester. The skilled person will also appreciate that mixtures of different fibres are also possible, for instance, nylon in a polyester braid, polyester and polypropylene, as well as other known mixtures of fibres. These materials have sufficient strength to make fibre ropes of a useable size, whilst at the same time, have low specific gravities (i.e. typically in the range of 1.6 to 0.9) Due to their low specific gravities, these fibre ropes may have a self-weight in water that is negligible; the ropes may even be buoyant, depending on the material. Using such ropes solves the problems associated with the reduction in useful capacity associated with steel wire.

As used herein, the term rope refers to a length of fibrous material having a diameter; the rope has tensile strength whilst being flexible. The fibrous material may be laid, twisted, braided or plaited, or interwoven in any other manner known to the skilled person to provide strength to the rope. The term fibre and fibrous materials is used to refer to elongated continuous filamentous materials having a low specific gravity, compared to non-fibrous materials, particularly materials having higher specific gravities such as steel. The rope may further comprise a coating; the coating may be fibrous or non-fibrous. The coating may surround the outer surface of the rope, and may be used to reduce friction between the rope and other surfaces, and/or protect the rope from damage.

As used herein, the term shallow water refers to a depth of water less than 1000 meters from the surface; the term deep water refers to a depth of water in the range of greater than or equal to 1000 meters to less than 3000 meters from the surface; the term very deep water refers to a depth of water greater than or equal to 3000 metres from the surface.

As used herein, the term “specific gravity” is defined as the ratio of the density of a given material (for instance, the material from which rope is made) to the density of water, when the densities of the given material and water are measured at the same temperature and pressure.

As used herein, the terms sheave, block and pulley may be used interchangeably, in accordance with the general knowledge of the skilled person. Thus, in a first aspect, the present invention provides a crane comprising a support structure, a lifting arm secured to the support structure and extending therefrom, at least one lifting rope extending from the support structure towards an end of the lifting arm remote from the support structure, the at least one lifting rope having a specific gravity less than 3, and a traction winch for moving the at least one lifting rope from the support structure along the arm and vice versa.

The support structure of the crane may be rotable about a vertical axis. The lifting arm may be movable with respect to the support structure. The crane may further comprise a movable lifting pulley mounted on the lifting arm, wherein the lifting pulley is moveable along the lifting arm. The support structure may comprise a crane pedestal. The support structure may comprise a crane mast. The crane may further comprise at least one storage means for storing the at least one lifting rope. The at least one storage means may comprise a reel and a reel drive. The crane may further comprise at least one sheave mounted at the end of the lifting arm remote from the support structure, for redirecting the at least one rope away from the lifting arm. The crane may further comprise at least one sheave mounted on the crane pedestal for redirecting the at least one lifting rope between the support structure and lifting arm. The crane may further comprise at least one sheave mounted on the crane mast for redirecting the at least one lifting rope between the support structure and lifting arm.

The at least one lifting rope may have a specific gravity of 2.5 or less, 2.0 or less, 1.6 or less, 1.5 or less, 1.4 or less, 1.3 or less or 1.2 or less. The specific gravity of the rope may be as low as 0.9, 0.8, 0.7, 0.6 or 0.5. In one embodiment, the specific gravity may be in the range of 0.5 to 3.0, or more preferably, have a specific gravity in the range of 0.5 to 1.6. The crane may comprise one, two, three, four or more lifting ropes. The lifting ropes may have diameters that are the same, or different. When there are a plurality of lifting ropes, the crane may further comprise a multi-connection plate, mounted at the end of the at least one lifting rope remote from the support structure, for connecting the lifting ropes. Alternatively, the crane may further comprise a lifting block, wherein the at least one rope remote from the support structure is run through at least one sheave mounted on the lifting block. A lifting hook may be attached to the lifting block for attaching a load to be lifted or lowered. When the crane comprises two or more lifting ropes, at least a pair of lifting ropes may be connected together and run through the at least one sheave mounted on the lifting block.

The crane may be configured in a single fall arrangement, wherein the length of rope paid out or recovered is substantially equal to the distance the lifting block is lowered or raised, respectively. Alternatively the crane may be configured in a double-fall arrangement, wherein the length of rope paid out or recovered is substantially double the distance the lifting block is lowered or raised, respectively. The at least one rope may be run through the at least one sheave of the lifting block, and the end thereof fixed to the crane.

The lifting rope may comprise a fibrous material. The fibrous material may comprise at least one synthetic fibre. The fibrous material comprises at least one nylon, and/or at least one para-aramide. The at least one para-aramide may be a poly-para-phenylene terephthalamide. Other suitable fibres include polyamide, polyester, polypropylene, Polyethylene, High Modulus Polyethylene and Liquid Crystal Aromatic Polyester fibres, as well as any combination of fibres.

The traction winch of the crane may be configured to provide tension to the lifting rope for lifting or lowering loads. The traction winch may comprise two rollers. The lifting rope may be inter-wound between the two rollers. The two rollers may be configured to provide friction to the cable. The traction winch may comprise at least one motor. The motor may have a motor torque that is not dependent on the amount of wire stored in the storage means.

In a further aspect, there is provided a use of a crane according to the present invention.

In a further aspect the present invention provides a method of lifting or lowering loads offshore comprising attaching a load to at least one lifting rope, the at least one lifting rope extending from a support structure of a crane and extending towards an end of the lifting arm remote from the support structure, the at least one lifting rope having a specific gravity less than 3, and lifting the load through or out of water, or lowering the load through or into water, by providing tension to the at least one lifting rope using at least one traction winch.

The method may further comprise the step of moving the load by any combination of: rotating the support structure about a vertical axis, moving the lifting arm, or moving a lifting pulley movably mounted on the lifting arm. The method may further comprise the step of paying out stored rope when lowering loads, or recovering and storing rope when lifting loads, whereby the at least one lifting rope is stored on a storage means.

The at least one lifting rope may have a specific gravity of 2.5 or less, 2.0 or less, 1.6 or less, 1.5 or less, 1.4 or less, 1.3 or less or 1.2 or less. The specific gravity of the rope may be as low as 0.9, 0.8, 0.7, 0.6 or 0.5. In one embodiment, the specific gravity may be in the range of 0.5 to 3.0, or more preferably, have a specific gravity in the range of 0.5 to 1.6 Two, three or four or more ropes may be used in parallel.

When at least two ropes are attached to the load, the method may further comprise the step of equalising tension between a pair of at least two ropes, by connecting the pair of ropes together, and running the pair of ropes through a sheave mounted on a lifting block remote from the support structure.

The load may be lifted or lowered with a mechanical advantage substantially equal to 2, by running the at least one rope through a sheave mounted on a lifting block remote from the support structure, and fixing one end of the rope remote from the traction winch to the crane.

The lifting rope of the method may comprise a fibrous material. The fibrous material may comprise at least one synthetic fibre. The fibrous material may comprise at least one nylon. The fibrous material may comprises at least one para-aramide. The at least one para-aramide may be a poly-para-phenylene terephthalamide. Other suitable fibres include polyamide, polyester, polypropylene, Polyethylene, High Modulus Polyethylene and Liquid Crystal Aromatic Polyester fibres, as well as any combination of fibres.

Constant tension may applied to the at least one lifting rope by the at least one traction winch in the present method. The lifting or lowering step may be heave-compensated and/or resonance-compensated.

The support structure in accordance with the present invention may comprise a number of components including pedestals and masts. Suitable support structures for use with the present invention include support structures built as a lattice framework, or box sections of any cross-section; the person skilled in the art will appreciate that other suitable support structure may be used.

It will be appreciated that a crane in accordance with the present invention may be built ab initio; in other words, a crane in accordance with the present invention may be designed, built and installed “from scratch”. Alternatively, existing cranes that, for instance, currently use steel wire as the lifting medium, may be modified into a crane of the present invention, in accordance with the general knowledge of the skilled person.

A variety of lifting arms may be used in accordance with the invention, including stiff booms, telescopic booms, knuckle booms, or booms that have both telescopic sections and joints. Stiff booms do not have any joints on the boom length. Knuckle booms, on the other hand, comprise joints along the boom length to allow bending of the boom, supported by hydraulic cylinders or the like; knuckle booms thereby allow for a load to be moved towards or away from the crane pedestal, or in other words, allow for an increase or decrease the lift radius. Telescopic booms extend or contract telescopically, thereby increasing or decreasing the lift radius. The lifting arm may be moveable with respect to the support structure. For instance, the lifting arm may be mounted on the support structure on a rotable horizontal axis, thus allowing the lifting arm to change its angle relative to the horizontal. Alternatively or additionally, the lifting arm may be provided with a travelling lift pulley and lifting hook which are movable along the lifting arm.

As discussed above, cranes suitable for use in shallow water use storage drums that both store the lifting wire medium and also provide the lifting force with suitable drive motors attached to the drum. To overcome the disadvantages of this particular configuration, a traction winch is used in accordance with the present invention, interposed between the load and the fibre rope storage reel.

A particularly advantageous configuration of a traction winch is described as follows. Two rollers are used to pull on the rope (i.e. to provide tension to the rope); the rope is inter-wound between the rollers with multiple turns to provide the necessary friction. The two rollers are driven by motors, and the whole arrangement is configured to provide the rope tension required to lift or lower loads without rope slippage. The rope emerging from the winch is taken up under low tension by a storage reel. The tension required to lift the load is provided entirely by the traction winch, thus allowing the storage reel to be driven by a relatively low power motor. The two rollers of the traction winch may be parallel. The two rollers or the traction winch may be tapered.

In an advantageous embodiment, the traction winch may be in the form of a plurality of separate sheaves, each of which are individually computer-controlled. The sheaves each have individual drives that are computer-controlled, so that the load in the fibre rope is near constant along its length from entry into the winch to exit. The separate computer-controlled individual sheaves are better able to accommodate any increased stretch between the multiple turns, and are able to prevent slippage between the turns, thereby preventing any heating of the rope and rope wear through slippage. In addition, the sheaves are configured relative to each other in such a way as to limit the side load on the fibre rope, with similar benefits. In accordance with this embodiment, the traction winch comprising the separate computer controlled sheaves may comprise two groups of mutually parallel sheaves, each sheave having a separate drive. The outer peripheral surface of the sheaves provides the necessary friction to the fibre rope. The power and speeds of the drives of each sheave may be separately adjustable in operation. The rope may be interwound between the two groups of sheaves.

This configuration using a separate traction winch and storage drum has several advantages over the standard configuration having storage drum that is also used to lift and lower loads. These advantages are particularly beneficial when applied to lifting/lowering operations in deep or very deep water, and/or when handling large lengths of rope.

The radii of action on the wire of the rollers of the traction winch configuration do not change as pay-out and/or recovery proceeds. Consequently, the drive torque needed by the traction winch may be constant. Furthermore the drive torque depends only on the roller size (which itself is determined by rope bend radius), and not on how many metres of large diameter wire is stored—consequently, drive torque may be relatively low compared to configurations involving storage drums that are also used to lift and lower loads.

In standard configurations, when storage drums are also used to lift and lower loads, the tension required to lift and lower the loads can be so great such that the outer layers of rope on the storage drum may be pulled into the inner layers, thus resulting in rope damage. The traction winch configuration of the present invention avoids this problem by using a lower tension to operate the separate storage reel.

In a further embodiment, the storage means may further comprise a level wind to ensure that the wire is fed evenly onto the drum, layer by layer of wire. On a direct reel hoist of prior art cranes, the level wind can be subject to a proportion of the relatively high lift load. On the other hand, in accordance with the traction winch and storage reel arrangement of the present invention, the level wind system is desirably only subjected to a relatively low storage tension. Another advantage is that the storage reel does not have to be adjacent to and/or directly in line with the traction winch, as the low tension in the lifting rope facilitates leading it around sheaves to the reel.

The present invention will be further described with reference to the drawings, in which:

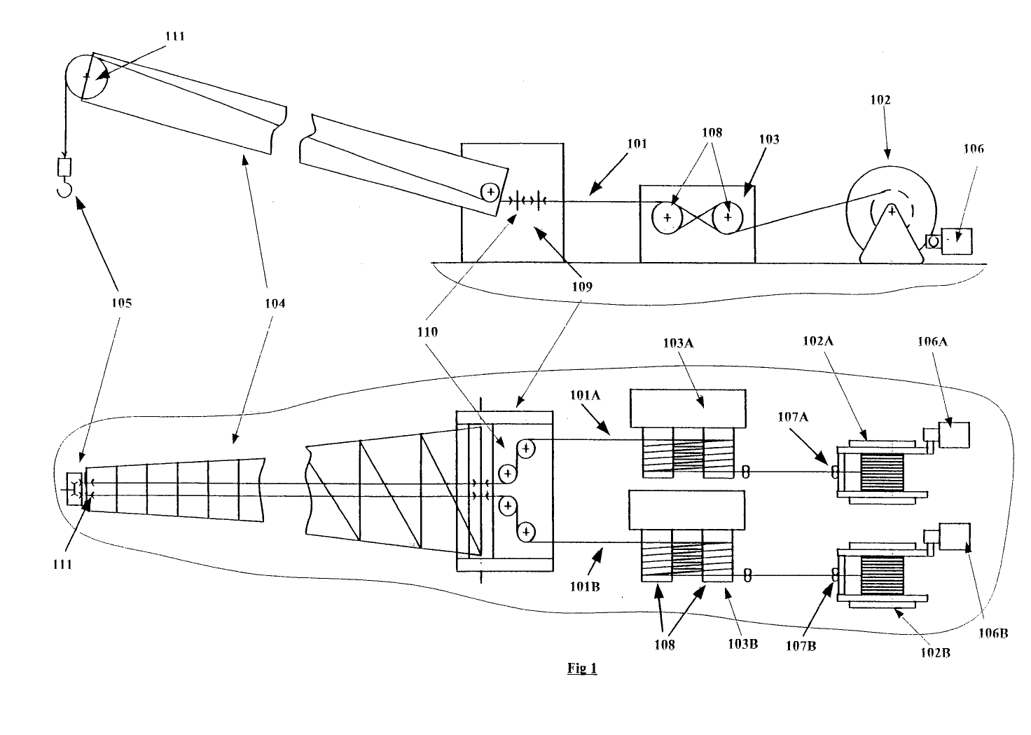

FIG. 1 shows a schematic view of a typical crane layout, which may be used to lift and lower loads in deep water in accordance with the present invention; the single fall/twin rope configuration is shown here, with a side-on view shown in the upper half of FIG. 1, and a plan view shown in the lower half;

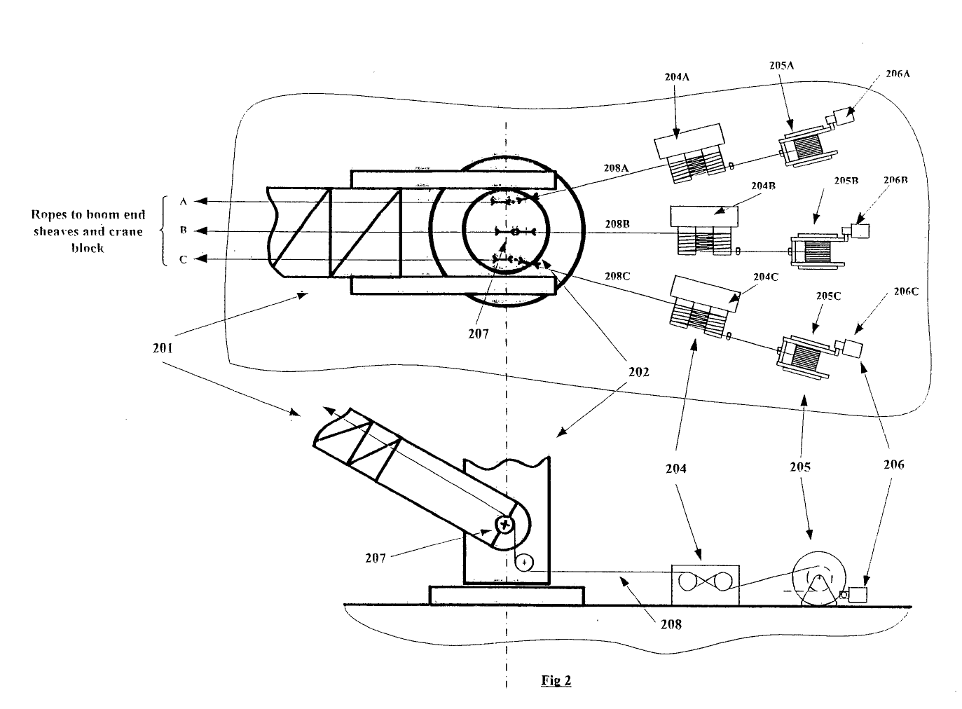

FIG. 2 shows a schematic view of another typical crane layout in accordance with the present invention; the single fall/three rope configuration is shown here;

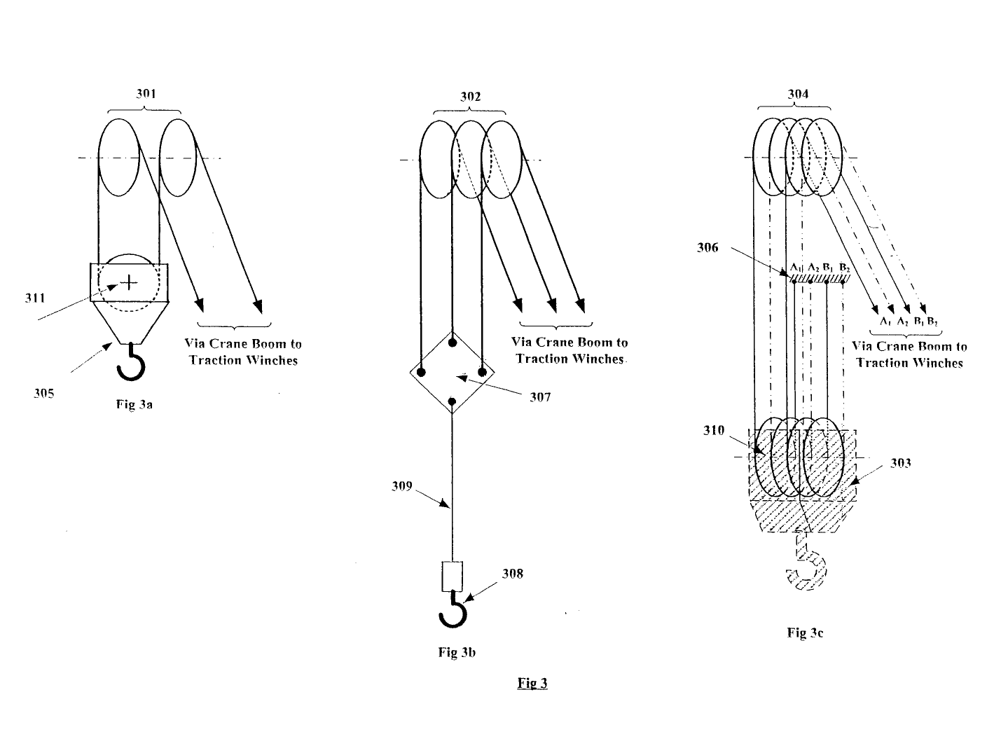

FIG. 3 shows schematic views of examples of single and multi-fall configurations for use with the present invention; FIG. 3a shows the single fall/twin rope configuration; FIG. 3b shows the single fall/triple rope configuration; and FIG. 3c shows the double-fall/quadruple rope configuration.

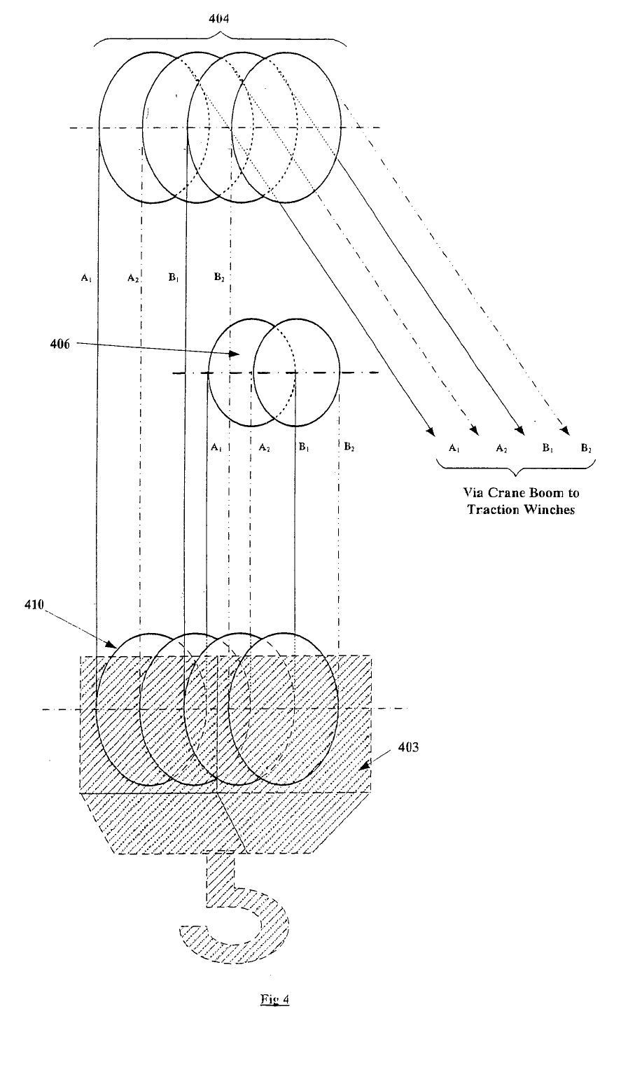

FIG. 4 shows a schematic view of an example of a double fall/quadruple rope arrangement, wherein the rope tension between each of two pairs of rope is equalised, in accordance with the present invention.

A typical configuration of a crane of the present invention is shown in FIG. 1. The top half of FIG. 1 shows the crane as viewed from the side, and the bottom half shows a plan view of the crane. The crane has a support structure in the form of a crane pedestal 109, and a lifting arm in the form of a crane boom 104. Two ropes 101 A, B are used in conjunction, with two traction winches 103 A, B, and two storage means each comprising corresponding storage reels 102 A, B, reel drives 106 A, B and level wind 107 A, B. The traction winches each comprise a pair of rollers 108. The crane further comprises a block with hook 105 mounted at the end of the rope remote from the crane support structure, adapted to support a load. The crane layout shown in FIG. 1 is shown with pedestal-mounted sheaves 110 and boom-end-mounted sheaves 111. Sheaves may generally be described as components comprising a wheel having a grooved circumference mounted on a shaft, whose ends are fixed within the structure. Sheaves are useful for changing direction of a rope running through the sheave. It will be appreciated by the person skilled in the art that sheaves may be used throughout the apparatus as required, in particular, where the rope changes direction.

In one embodiment of the present invention, the number of ropes used may be varied. Any number of ropes may be used, including one, two, three, four, five, six or more ropes. The number of ropes used may be an even or an odd number. Using multiple ropes may allow use of a fibre rope having a reasonable diameter that is easier to use and handle than larger diameter ropes.

In the configuration shown in the plan view schematic of FIG. 1, the crane is shown with two parallel ropes 101 A, B. This arrangement involving two parallel ropes allows the load to be shared between the ropes.

Another typical crane layout of the present invention is shown in FIG. 2. The bottom half of FIG. 2 shows the crane as viewed from the side, and the top half shows a plan view of the crane. The crane comprises a support structure in the form of a crane mast 202, and a lifting arm in the form of a crane boom 201. Three ropes 208 A, B, C are used in conjunction, with three traction winches 204 A, B, C, and three storage means each comprising corresponding storage reels 205 A, B, C and reel drives 206 A, B, C. The crane further comprises mast-mounted sheaves 207. It will be appreciated that where multiple ropes are used, the diameters of the ropes may be the same, or may be different from each other.

It will also be appreciated that apparatus may be configured in a single fall arrangement or a double fall arrangement.

As used herein, the term “single fall arrangement” refers to a configuration where the lift wire is connected directly to the crane hook. In a single fall arrangement, the length of wire paid out or recovered is substantially the same as the distance a load attached to the crane is lowered or lifted, respectively. In other words, in a single fall arrangement, there is no “mechanical advantage”, in that the amount of input force (by applying tension to the string) is substantially the same as the output force (applied to the load). Examples of single fall twin and triple wire arrangements are shown in FIG. 3a and FIG. 3b, where the twin and triple boom end sheaves are denoted by 301 and 302, respectively.

As used herein, the “double fall arrangement” refers to a configuration wherein the load to be lifted is attached to a crane hook. This incorporates a single sheave. One end of the rope is fixed to the apparatus. The other end then passes around the sheave in the crane block, and also those in the crane boom, and thence to the traction winch. The latter is used to pay out or recover the rope as required. In a double fall arrangement, the length of wire paid out or recovered is substantially double the distance a load attached to the crane is lifted or lowered, respectively. In other words, in a double fall arrangement, there is a “mechanical advantage” of 2, in that the amount of input force (by applying tension to the string) is substantially half the output force (applied to the load). An example of a twin double fall arrangement is shown in FIG. 3c; where the two×twin boom end or fixed pulleys are denoted 304, and a matching set of pulleys in the crane block are denoted 310.

It will be further appreciated that higher order fall arrangements (triple fall or higher) may be used by increasing the number of pulleys in the arrangement to increase the mechanical advantage, in accordance with the general knowledge of the skilled person.

Where multiple ropes are used, the apparatus will have, inter alia, the corresponding number of pulleys or sheaves. For instance, in the single fall/twin rope arrangement shown in FIG. 3a, there are two boom end or fixed pulleys, generally on a common axle, one pulley for each rope. In the single fall/triple rope arrangement shown in FIG. 3b, there are three boom end or fixed pulleys having the same axle, one for each rope. In the double fall/quadruple rope arrangement shown in FIG. 3c, there are four boom end or fixed pulleys and four pulleys mounted in the crane block 303, with one fixed pulley and one block-mounted pulley for each rope.

Where there are at least two ropes in use, in a single fall arrangement, a pair of the ropes may be connected, and passed around an equalising sheave that enables the tension in the pair of ropes to be equalised therebetween. An example of an apparatus incorporating an equalising sheave is shown in FIG. 3a, denoted 311, located in the weighted crane block and sheave 305. The equalising sheave allows the block to hang level, and to accommodate any differences between the lengths paid out/recovered by the winches associated with each of the ropes. Where there are four ropes, each of two pairs of ropes may be equalised by equalising sheaves; where there are six ropes, each of three pairs of ropes may be equalised by equalising sheaves, and so on. Although the equalising sheave, located in the crane block 305, is shown in the single fall arrangement of FIG. 3a, other configurations may be adopted in accordance with the present invention. FIG. 4 shows the double fall/quadruple rope arrangement, wherein rope tension between each of two pairs of ropes is equalised. Two equalising sheaves 406 are mounted on the crane, where one equalising sheave is configured to equalise tension between one pair of the ropes A1 and B1, and the other equalising sheave equalising tension between the other pair of ropes A2 and B2. There are four boom-end mounted pulleys 404 for each of the ropes, and four block-mounted pulleys 410 mounted in the block 403, for each of the ropes.

Alternatively, where the apparatus comprises multiple ropes, the ropes may be connected to a multi-connection plate. FIG. 3b shows an example of a multi-connection plate 307 connecting three ropes. The load to be lifted or lowered may be suspended using a weighted hook 308, the hook suspended from a rope/wire pennant 309.

As the rope may be substantially “weightless” (i.e. having a low or negligible self-weight) in water, it may be necessary to ensure that the crane block (for instance 305 or 303), or the crane hook (e.g. 308), is suitably weighted, especially in conditions involving underwater currents. Furthermore, it may be necessary to combine the crane operation with a clump weight in order to avoid excessive lateral displacement of the block. In accordance with the general knowledge of the person skilled in the art, a clump weight in essence is a heavy sea bed “anchor” using gravity rather than embedded flukes to its maintain position against a load.

The traction winches 103 A, B and storage reels 102 A, B are configured to work in combination, as described as follows, with reference to the crane apparatus shown in FIG. 1. The storage reels 102 A, B will be driven by reel drives 106 A, B, controlled so as to maintain a suitable tension in the ropes 101 A, B as it is paid out to, or recovered from, the traction winches 103 A, B. The tension applied to the ropes 101 A, B by the reel drives 106 A, B is typically constant, or may vary with storage diameter. The storage diameter of the storage reels 102 A, B will depend on how much rope is stored at any given time; the more rope is stored on the reel, the greater the storage diameter. The tension applied by the reel drives 106 A, B to the ropes 101 A, B is sufficiently high so as to pay out or recover rope to the traction winches 103 A, B as required, but at the same time sufficiently low as to prevent the ropes on the upper layers of stored rope on the storage reels 106 A, B from penetrating the lower layers of rope. The rope may be wound on (and wound or freely spooled off) the storage reels 106 A, B via level wind systems 107 A, B, whose design and operation is greatly facilitated by the low tension applied by the reel drives 106 A, B. The above-described combination of the traction winches 103 A, B, storage reels 102 A, B and drives 106 A, B, inter alia, prevents rope damage that may occur with prior art configurations, where the higher tensions applied to the rope on the storage reel result in the outer layers of stored rope to be pulled into the inner layers.

The apparatus of the present invention may be controlled in a variety of ways. The apparatus may be wholly manually controlled, or controlled using a computer.

The apparatus may be configured to operate with constant tension when lifting or lowering loads, or with a variable tension.

The present apparatus may be operated with heave compensation in accordance with the general knowledge of the skilled person. Heave compensation allows for cancelling out of the ship movements at the load when operating in a seaway, which would otherwise move un-predictably, thereby preventing potential damage to the load.

It may also be particularly advantageous to operate the apparatus with compensation for resonance effects, which may be more pronounced with fibre ropes than in steel ropes. The elasticity of a rope is a function of length and/or material of a given rope. Fibre rope is more elastic than steel, and so load resonance effects are more pronounced, even more so in deep and very deep water. The increased movement in turn increases the risk of load damage when operating in a seaway, which can be mitigated by compensating for the increased resonant effects. Heave compensation can be achieved, for instance, using a heave compensation apparatus comprising a vessel motion measurement device, which may be in the form of a motion reference unit for measuring the motion of the vessel, and a control device or computer capable of receiving an output from the vessel motion measurement device and controlling the crane according to the movement of the vessel, so as to stabilise a load attached to the crane. The heave compensation apparatus may further comprise a lift wire tension measuring device for measuring the tension in the lift wire, a lift wire distance measurement device which measures the length of lift wire that has been paid out, a load motion measurement device for measuring the motion of the load, or any combination thereof.

It will be appreciated that the invention may be modified within the scope of the appended claims.

1-65. (canceled)

66. A crane comprising:
(a) a support structure;
(b) a lifting arm secured to the support structure and extending therefrom;
(c) at least one lifting rope extending from the support structure towards an end of the lifting arm remote from the support structure, the at least one lifting rope having a specific gravity less than 3;
(d) a traction winch for moving the at least one lifting rope from the support structure along the arm and vice versa.

67. A crane according to claim 66 further comprising a movable lifting pulley mounted on the lifting arm, wherein the lifting pulley is moveable along the lifting arm.

68. A crane according to claim 66 further comprising a reel and a reel drive for storing the at least one lifting rope.

69. A crane according to claim 66, wherein the at least one lifting rope has a specific gravity of 1.6 or less.

70. A crane according to claim 66 comprising two or more lifting ropes.

71. A crane according to claim 70, further comprising a multi-connection plate, mounted at the end of each lifting rope remote from the support structure, for connecting the lifting ropes.

72. A crane according to claim 66, further comprising a lifting block, wherein the at least one rope remote from the support structure is run through at least one sheave mounted on the lifting block.

73. A crane according to claim 72, when comprising two or more lifting ropes, at least a pair of lifting ropes are connected together and run through the at least one sheave mounted on the lifting block.

74. A crane according to claim 72 configured in a double-fall arrangement, wherein the length of rope paid out or recovered is substantially double the distance the lifting block is lowered or raised, respectively.

75. A crane according to claim 74, wherein the at least one rope is run through the at least one sheave of the lifting block, and wherein the end of the at least one lifting rope is fixed to the crane.

76. A crane according to claim 66 wherein the lifting rope comprises a fibrous material.

77. A crane according to claim 66 wherein the traction winch comprises two parallel tapered rollers, wherein the lifting rope is interwound between the two rollers.

78. A crane according to claim 66 wherein the traction winch comprises a plurality of sheaves arranged in two groups of mutually parallel sheaves, wherein each of the plurality of sheaves of the traction winch are separately controlled.

79. A crane according to claim 66 wherein the traction winch comprises at least one motor, with a motor torque which is not dependent on the amount of wire stored in a storage structure.

80. A method of lifting or lowering loads offshore comprising:
(a) attaching a load to at least one lifting rope, the at least one lifting rope extending from a support structure of a crane and extending towards an end of the lifting arm remote from the support structure, the at least one lifting rope having a specific gravity less than 3; and
(b) lifting the load through or out of water, or lowering the load through or into water, by providing tension to the at least one lifting rope using at least one traction winch.

81. A method according to claim 80 wherein two, three, four, or more ropes are used in parallel.

82. A method according to claim 80, when at least two ropes are attached to the load, tension between a pair of at least two ropes being equalized by connecting the pair of ropes together and running the pair of ropes through a sheave mounted on a lifting block remote from the support structure.

83. A method according to claim 80, wherein the load is lifted or lowered with a mechanical advantage substantially equal to 2, by running the at least one rope through a sheave mounted on a lifting block remote from the support structure, and fixing one end of the rope remote from the traction winch to the crane.

84. A method according to claim 80, wherein a pulling force is applied to the at least one lifting rope by a storage means on which the lifting rope is stored, wherein the pulling force is lower in magnitude than a tension provided by the traction winch.

85. A method according to claim 80, wherein the lifting or lowering step is heave-compensated, resonance-compensated, or both.
